(19) United States
(12) Patent Application Publication
(10) Pub. No.: US 2008/0178992 A1
(43) Pub. Date: Jul. 31, 2008

(54) Porous Substrate and Method of Fabricating the Same

(75) Inventors: Sunilkumar C. Pillai, North Billerica, MA (US); James Jenq Liu, Mason, OH (US); Bilal Zuberi, Cambridge, MA (US)

Correspondence Address: GEO2 TECHNOLOGIES, 12-R CABOT ROAD, WOBURN, MA, 01801, US

(73) Assignee: GEO2 TECHNOLOGIES, INC., Woburn, MA (US)

(21) Appl. No.: 11/669,488

(22) Filed: Jan. 31, 2007

(51) Int. Cl. B32B 3/12

(52) U.S. Cl. 156/197; 428/116

(57) ABSTRACT

A porous substrate produced by an extrusion process consisting essentially of bonded fibers is fabricated as a segmented substrate by joining a plurality of substrate segments with an adhesive that comprising fibers. The adhesive is bonded to fibers in the substrate segments to provide mechanical strength of the segmented substrate. The fibers in the adhesive provide a reduced elastic modulus in the adhesive layer that maintains a highly elastic structure between the segments in order to mitigate thermally induced mechanical stress when thermal gradients develop within the porous substrate during operation. The segmented porous fibrous substrate disclosed can be fabricated from a variety of materials to provide for effective filtration and as a catalytic host in various applications, including exhaust filtration of internal combustion engines.

### BACKGROUND OF THE INVENTION

This invention relates generally to a porous filtration substrate, and more particularly to the fabrication of an extruded fibrous honeycomb filtration substrate.

Porous substrates are commonly used for filtration of fluids and gases, including exhaust gases of internal combustion engines. Porous substrates can be coated with a washcoat or catalyst to accelerate chemical reactions of the filtrate. For example, a diesel particulate filter can be constructed from a porous substrate to extract particulate matter from the exhaust of a diesel engine. A catalyst coating disposed within the substrate facilitates the oxidation of soot particles into carbon dioxide and water to prevent accumulation of particulates in the filter that would otherwise cause a reduction in engine performance.

Porous ceramic substrates are particularly useful in filtration applications that involve relatively high operating temperatures and/or chemically severe environments. By selecting appropriate materials and fabrication methods, porous substrates can be designed to withstand harsh operating environments while maintaining structural integrity.

Porous substrates are often specified in a honeycomb form to maximize surface area exposure of the substrate material and filtration media to the filtrate. Honeycomb substrates are usually most economically fabricated using an extrusion process. Ceramic material is mixed with a binder and a fluid to form an extrudable mixture, which is forced under high pressure through an extrusion die. The extruded substrate is cured at high temperatures to remove the fluid, burn off the binder, and harden the substrate into its final state. Catalytic converters, commonly used in the exhaust systems of nearly all modern vehicles, are typically extruded from ceramic materials into a monolithic honeycomb substrate.

Extrusion of honeycomb substrates becomes increasingly difficult as the size of the monolithic substrate increases. Various methods have been developed to fabricate large size honeycomb substrates by adhering cured substrate sections together to form a segmented substrate. Additionally, large substrates have an increased susceptibility to structural defects due to thermal gradients in operation. A large thermal gradient that builds up in a substrate may cause cracks in the material if the coefficient of thermal expansion of the substrate material permits the buildup of stresses that exceed the material strength. Isolation of thermal gradients can also be provided by fabricating the honeycomb substrate with individual filter modules or segments, each segment essentially glued to an adjacent segment using a compliant adhesive material. Mechanical properties of the adhesive material, such as elastic modulus, and coefficient of thermal expansion can provide for improved thermal shock tolerance with segmented substrates over monolithic substrates. Current methods of assembling segmented substrates provide compliant sealing materials that maintain a gas-tight seal with thermal isolation between sections while permitting thermal expansion of the segments without causing cracks in the segments. Irregularities at the interface between the adhesive material and the segment often results in adhesion problems that can compromise the integrity of the adhered substrate.

Porous substrates made from the extrusion of fibrous materials have significantly higher levels of porosity than powder-based ceramic materials with equivalent or improved material strength. The microstructure of the bonded fibrous material within a fiber based porous structure has improved thermal characteristics over powder-based products such that larger substrates are less susceptible to internal cracking when exposed to thermal gradients. Accordingly, there is a need for a porous substrate that can be fabricated with increased efficiency and improved thermal and mechanical properties.

### BRIEF SUMMARY OF THE INVENTION

The present invention provides a porous fibrous substrate with increased efficiency of fabrication and improved thermal and mechanical properties. The substrate is produced by an extrusion process that extrudes an extrudable mixture of fibers, additives, and fluid into a plurality of fibrous honeycomb substrates. Once cured, the fibrous honeycomb substrates are joined with an adhesive comprising bonding fibers, that are bonded to the fibers of the substrate to form bonds that provide superior mechanical strength while maintaining a highly elastic structure between the segments.

In an embodiment of the invention, ceramic fibers are mixed with additives and a fluid, such as water, to provide a mixture of sufficient rheology to extrude into a green honeycomb substrate. In this embodiment, additives including organic binders and pore formers are used so that when cured, the effective porosity of the substrate is greater than 50%. Such a porous bonded-fiber based substrate has higher porosities that are required for low backpressure, with high catalyst coatings, lower thermal mass, and lower comparative costs. This highly porous honeycomb substrate is joined with other extruded substrate segments to provide a segmented substrate using an adhesive that includes, among other constituents, ceramic fibers. The composition of the adhesive is particularly designed to operate at elevated temperatures during operation, provide a low elastic modulus at the interface between substrate segments, form fiber-to-fiber bonds across the adhesive and substrate interfaces to provide mechanical strength to the substrate and for adhesion, and provide chemical resistance and compatibility with the intended application. These characteristics are provided as bonds form between the fibers of the substrates and the adhesive layer in a curing operation after assembly.

Other embodiments of the invention are shown, including extruded substrate segments made from various compositions of fibers, and a mixture of various fibers, all joined to adjacent substrate segments using a fiber-based adhesive.

These and other features of the present invention will become apparent from a reading of the following descriptions, and may be realized by means of the instrumentalities and combinations particularly pointed out in the appended claims.

### BRIEF DESCRIPTION OF THE SEVERAL VIEWS OF THE DRAWING

FIG. 1 shows an exploded view of a porous fibrous substrate composed of extruded honeycomb substrate segments.

FIG. 2 depicts a plurality of fibrous honeycomb substrate segments joined in a final configuration.

FIG. 3 shows a flowchart describing the method of the present invention.

FIG. 4 shows a plan view of a plurality of substrate segments joined into a segmented substrate.

FIG. 5 shows a detailed view of the plurality of substrate segments with an adhesive applied in accordance with the present invention.

FIG. 6 shows a detailed view of the plurality of substrate segments after the adhesive layer is cured with bonds formed to the fibers of the substrate segments.

FIG. 7 depicts a detailed view of the interface between the adhesive layer and two adjoining segments.

FIG. 8 depicts a segmented filter assembled from a plurality of sub-circular segments.

FIG. 9 depicts a segmented filter assembled from a plurality of wedge-shaped segments arranged around a cylindrical segment.

FIG. 10 depicts the application of the present invention in a diesel particulate filter.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

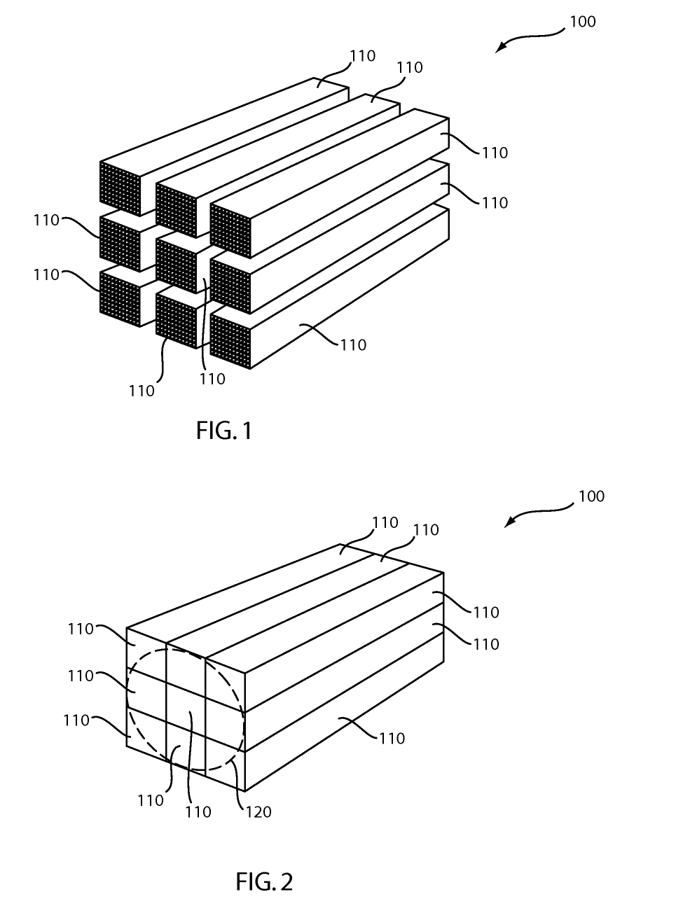

Referring to FIG. 1, an exploded view of a segmented porous fibrous substrate 100 is shown. The segmented porous fibrous substrate 100 is fabricated by assembling a plurality of individually extruded honeycomb substrate segments 110. As shown in FIG. 2, the plurality of honeycomb substrate segments 110 can be joined and shaped into a final filtration substrate configuration. For example, a cylindrical filter can be formed from the rectangular segments, as shown by the outline of a cylindrical pattern 120.

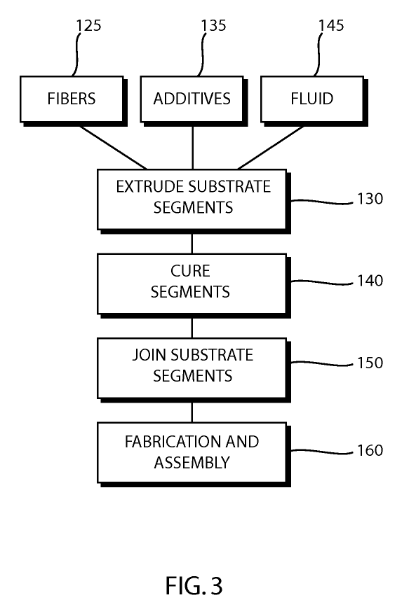

FIG. 3 depicts a method of fabricating a segmented porous fibrous substrate according to the present invention. The method begins with the extrusion of the honeycomb substrate segments 110 at step 130. Extrusion of fiber-based materials to form porous substrates is disclosed in commonly assigned U.S. patent applications Ser. No. 11/323,429, filed Dec. 30, 2005 entitled “An Extruded Porous Substrate and Products using the Same,” Ser. No. 11/322,477, filed Dec. 30, 2005 entitled “Process for Extruding a Porous Substrate,” and Ser. No. 11/323,430, filed Dec. 30, 2005 entitled “An Extrudable Mixture for Forming a Porous Block,” all of which are herein incorporated by reference in their entirety.

As shown in FIG. 3, the extrusion step 130 begins with the combination of fibers 125, additives 135, and a fluid 145. Generally, fibers 125 can be organic or inorganic fibers, such as ceramic fibers, organic fibers, polymeric fibers, oxide fibers, vitreous fibers, glass fibers, amorphous fibers, crystalline fibers, non-oxide fibers, such as carbide fibers, nitride fibers, metal fibers, other inorganic fiber structures, or combinations thereof An exemplary list of fibers 125 can include, without limitation, mullite; alumina; silica; blends of alumina and silica; blends of alumina; silica and aluminosilicate; aluminaborosilicate; silicon carbide; silicon nitride; cordierite; NEXTEL® (312, 440, 550, 610, 650, 720); YAG (yttrium aluminum garnet) fibers and the AETB compositions; alumina-mullite; alumina-silica-zirconia; alumina-silica-chromia; magnesium-silicate; magnesium strontium silicate; magnesium calcium strontium silicate; biosoluble fibers, such as alkali metal and alkali-earth metal compounds, cordierite fiber; fiber-glass; e-glass; aluminum titanate fiber; strontium titanium oxide; titania fiber; titanium carbide fiber; calciumaluminasilicate; barium aluminosilicate; barium strontium aluminosilicate; NEXTEL fibers; almax fibers; fibrox fibers; polyster fibers; aramid fibers; carbon fibers; hoskins; inconel; hastelloy; yittrium nickel garnet; fecralloys; phenolic fibers; polymeric fibers; cellulose; keratin; kevlar; nylon; polytetrafluoroethylene; teflon; kynol; mylar; zircon fibers; nickel; copper; brass; stainless steel; nickel chromium; and Ni₃Al. The fibers 125 are selected to be suitable for, and compatible with, the intended application of the extruded filter. For example, in the filtration of exhaust gas from an internal combustion engine, or as a diesel particulate filter, mullite fibers have been effectively demonstrated.

Mullite is a fiber that falls in the class of aluminicolicate (alumina and silica) fibers. Mullite fiber is a compatible fiber due to its exceptional high temperature properties, such as high resistance to thermal shock and thermal stress distribution arising from its low coefficient of thermal expansions, good strength and interlocking grain structure. Mullite is also characterized by relatively low thermal conductivity and high wear resistance, including resistance to harsh chemical environments. These properties do not suffer much at elevated temperatures, allowing the porous substrate to remain useable at high temperatures. Mullite is the mineralogical name given to the only chemically stable intermediate phase in the SiO₂—Al₂O₃ system. The natural mineral is rare, though found on the Isle of Mull off the west coast of Scotland. Mullite is commonly denoted as 3Al₂O₃.2SiO₂ (i.e., 60 mol % Al₂O₃ and 40 mol % SiO₂). However, this is misleading since mullite is actually a solid solution with the equilibrium composition limits of between about 60 and 63 mol % alumina below 1600 degrees Celsius.

Generally, a fiber is considered to be a material with a generally circular cross section with a relatively small diameter having an aspect ratio greater than one. The aspect ratio is the length of the fiber divided by the diameter of the fiber. As used herein the ‘diameter’ of the fiber assumes for simplicity that the sectional shape of the fiber is a circle; this simplifying assumption is applied to fibers regardless of the actual sectional shape, however, the fiber diameter could have any cross-sectional shape, such as an irregular shape to increase the effective surface area of the fiber. For example, a fiber with an aspect ratio of 10 has a length that is 10 times the diameter of the fiber. The diameter of the fibers 125 may be approximately 6 microns, although diameters in the range of about 1 micron to about 25 microns are readily available. It will be understood that fibers of many different diameters and aspect ratios may be successfully used in the extruded segments 110. Fibers can be made using a variety of techniques, such as, sol-gel spinning, melt-spun, viscous solution spinning, electrospinning, etc. As used herein, fibers are typically polycrystalline or amorphous materials having an aspect ratio greater than one, though fibers can also be monocrystalline structures having an aspect ratio greater than one, such as whiskers.

Additives 135 are used to provide extrudablility of the mix, and also to impart certain characteristics in the final product. For example, the additives 135 may comprise a pore former that effectively occupies space in the extruded segment 110 until it is removed during the subsequent curing step 140, leaving a pore or a void in the material. Pore formers can include carbon or graphite particles or flakes, wood flour, starch, cellulose, shell powder, such as coconut shells, husks, latex spheres, bird seeds saw dust and pyrolyzable polymers. The additives 135 may also comprise organic and inorganic binders that provide additional strength, or promote the propagation of fiber-to-fiber bonds during the subsequent curing step 140. Organic binder additives 135 can include thermoplastic resins, thermosetting resins, waxes, cellulose, dextrines, chlorinated hydrocarbons, starches, gelatins, acrylics, gums, albumins, proteins, and glycols. Inorganic binder additives 135 can include kaolin, bentonite, colloidal silica, colloidal alumina, borophosphates, soluble silicates, soluble aluminates, and soluble phosphates, in any number of forms, such as powders, solutions, hollow spheres and aerogels. An illustrative embodiment is provided by mixing mullite fibers with hydroxypropyl methylcellulose (HPMC) as an organic binder, and bentonite with colloidal silica as an inorganic binder. Carbon particles, such as graphite particles, are added as a pore former, and deionized water is used as the fluid. One skilled in the art will appreciate that this embodiment is illustrative in nature, and any number of alternative materials, including those mentioned above, and others, such as plasticizers, extrusion aides and sintering aides, can be mixed into an extrudable mixture, to be extruded into a porous substrate.

The fibers 125, additives 135 and fluid 145 are mixed to a homogeneous mass in a mixing process that may include dry mixing, wet mixing and shear mixing/kneading to ensure a uniform distribution of the constituents of the mixture. The rheology of the mixture may be adjusted during the mixing process to attain a rheology suitable for extrusion. By distributing the fibers 125 throughout the homogeneous mass, the fibers form a tangled, intersecting relationship with other fibers, with the additives 135 and fluid 145 completely surrounding and supporting the tangled fibers 125 in a substantially homogeneous mass.

The mixture is then extruded into a green substrate. The extrusion process may be performed using a ram extruder that pressurizes the extrudable mixture using hydraulic pressure. One skilled in the art will appreciate the variety of methods that can be used for extrusion, including, for example a screw extruder, wherein the mixing process occurs within the extrusion equipment instead of a standalone mixer. It is anticipated that several different kinds of mixers, blenders, and kneaders can be used to perform the mixing step. In the extrusion process, the extrudable mixture is forced under high pressure through a honeycomb extrusion die to form a honeycomb substrate section 110. One skilled in the art of extrusion of powder-based honeycomb ceramic materials will appreciate the variety of substrate sizes and geometries that can be produced in an extrusion process. As shown in the exemplary embodiments in the accompanying drawings, a rectangular cross section is particularly adapted for assembly into a segmented substrate. After extrusion at step 130, the green substrate composed of the extruded mixture of fibers 125, additives 135 and fluid 145 has sufficient green strength to hold its shape and fiber arrangement during the subsequent curing process 140.

The curing process 140 is performed in a series of stages. The first stage is the removal of fluid from the green substrate. Typically, water is used as the fluid 145, and the first stage of the curing process 140 can remove the water most readily using heat. Methods for drying the green substrate can be performed using conventional forced convection, or using electromagnetic radiation, such as microwaves or Radio Frequencies (RF) that excite water molecules, leading to evaporation and drying. Microwave or RF heating is preferred over forced convection due to the uniformity of heating the substrate, which is important to prevent cracks. Two or more heating mechanisms can be used sequentially, or substantially simultaneously, to dry the substrate. A first stage curing process using microwave or RF energy can be difficult to control when constituents of the extrudable mixture have electrical conductivity. For example, in the illustrative embodiment, the graphite particles increase the electrical conductivity of the extruded material, and the application of RF energy must be modulated to prevent excessive temperatures. The heat applied to the green substrate in the initial drying stage can also activate constituents of the additives 135 to further enhance the green strength of the green substrate segment. For example, if a methylcellulose polymer, such as the HPMC of the illustrative embodiment, is used as an organic binder in the additives 135, gelation of the polymer will occur during the drying stage, resulting in a three-dimensional network of the methylcellulose binder that prevents collapse or deformation of the structure during the drying phase as the water is removed. In the illustrative embodiment, green substrates are dried in RF to remove the fluid, and the process is controlled by modulating or otherwise adjusting RF energy so that the temperature of the green substrates does not exceed a maximum temperature of approximately 135 degrees Celsius.

The second stage of the curing process 140 is typically performed at a higher temperature than the first drying stage, to burn out the organic constituents of the additives 135. Binders and pore formers may be selected according to the type of fibers selected, as well as other desired characteristics. The binder is selected for its ability to provide and maintain the green state strength of the extruded substrate segment. Organic binders, such as the hydroxypropyl methylcellulose binder and organic pore formers, such as carbon powder or polymethyl methacrylate (PMMA), can be removed from the substrate segment, while maintaining the tangled and intersecting relationship of the fibrous structure. This second stage of the curing process 140 requires controlled time and temperature processing to remove volatile material without affecting the physical shape or structure of the substrate. For example, in the illustrative embodiment, a binder burnout process can be performed by first decomposing the organic binder HPMC by heating the substrates to 325 degrees Celsius in an inert environment, such as nitrogen or helium, for three hours. Next, the carbon pore former is removed by heating the substrates to 1000 degrees Celsius with air injection for 28 hours. The exact time and temperature profiles used depends on the materials used as additives 135, such as binders, and pore formers. The addition of air in the heated environment is necessary to permit the carbon particles to oxidize into CO₂. At this point, the substrate will consist of a highly porous and mechanically fragile network of intertangled fibers with inorganic materials distributed throughout, while maintaining the extruded honeycomb form.

The final stage of the curing process 140 is typically performed at even higher temperatures to sinter the substrate segment through the formation of fiber-to-fiber bonds. In the illustrative embodiment, the binder is selected to include inorganic constituents that facilitate a particular type of solid state or liquid state bonding between the selected fibers. Also, the binder is selected for its ability to plasticize the selected fiber. More particularly, the binder has a component, which at a bonding temperature, reacts to facilitate the flow of a liquid bond to the nodes of intersecting fibers. In some embodiments, a sintering aide may lead to facilitate the formation of sintered bonds across the fiber-to-fiber interfaces. Inorganic constituents of the additives 135 are dispersed throughout the tangled fibrous structure to promote the propagation of the fiber-to-fiber bonds within the substrate segment 11O. The fiber-to-fiber bonding process during the curing step 140 may be a liquid state sintering, solid-state sintering, or a bonding requiring a bonding agent, such as glass-former, glass, clays, ceramics, ceramic precursors or colloidal sols. In some cases, a reaction based sintering takes place, where bonds are created as a result of a chemical reaction and the formation of new ceramic material occurs across the bonds. The bonding agent may be part of one of the fiber constructions, a coating on the fiber, or a component in one of the additives. It will also be appreciated that more than one type of fiber may be used. It will also be appreciated that some fibers may be consumed during the curing and bonding process. The specific timing and temperature required to create the bonds depends on the type of fibers used, type of bonding aids or agents used, and the type of desired bond. In one example, the bond may be a liquid state sintered bond generated between fibers. Such bonds are assisted by glass-formers, glasses, ceramic pre-cursors or inorganic fluxes present in the system. In another example, a liquid state sintered bond may be created using sintering aids or agents. The sintering aids may be provided as a coating on the fibers, as additives, from binders, from pore formers, or from the chemistry of the fibers themselves. Also, the inorganic bond may be formed by a solid-state sintering between fibers. In this case, the intersecting fibers exhibit grain growth and mass transfer, leading to the formation of chemical bonds at the nodes and an overall rigid structure. In the case of liquid state sintering, a mass of bonding material accumulates at intersecting nodes of the fibers, and forms the rigid structure. It will be appreciated that the curing process may be done in one or more ovens, and may be automated in an industrial tunnel or kiln type furnace. In the illustrative embodiment, the final sintering stage of the curing process 140 increases the temperature of the substrate to 1500 degrees Celsius for one hour in stagnate air. In this final stage, inorganic bonds are formed at and near the nodes of the intertangled fibers, resulting in a mechanically robust substrate, with a porosity of greater than 50%, and typically between 60% and 80%.

The heating times and temperatures provided are merely exemplary values for the illustrative embodiment described herein. Alternative heating times, temperatures, and environments can be used for not only the illustrative embodiment, but also for any number of alternative embodiments to provide extruded substrate segments 110. For example, materials such as cordierite fibers will require lower sintering temperatures due to the lower glass transition temperature of the material. Alternatively, silicon carbide fibers are capable of withstanding higher sintering temperatures. Further still, alternative heating environments, such as inert environments such as argon, helium, neon, xenon, radon, nitrogen, or krypton can be used, as well as reactive environments such as hydrogen, oxygen, or carbon dioxide, can be adapted as needed for any stage of the curing process 140.

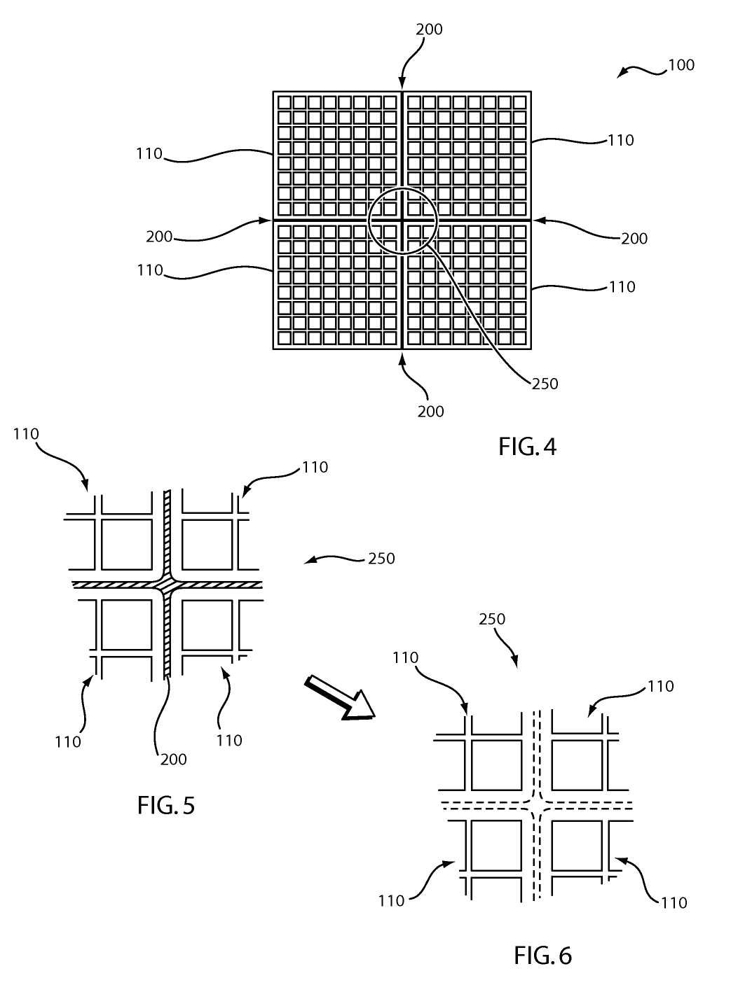

Referring still to FIG. 3, the cured fibrous substrate segments 110 are then joined to form a segmented porous fibrous substrate 100 at step 150. Referring now to FIG. 4, a plurality of extruded honeycomb substrate segments 110 are shown joined together with an adhesive material 200. The adhesive 200 contains inorganic binder, organic binder, and fibers that during the joining step 150, become engaged with and bonded to the fibers of the substrate segment 100 on its outer peripheral surface. These fiber-to-fiber and fiber-to-adhesive bonds provide a uniform and predictable bond having a strength nearly equivalent to that of the substrate segment 110. The strength of the adhesive 200 is desirably less than the substrate segment 110, but no so much less that it is mechanically less stable in its intended operating environment. The fiber-to-fiber and fiber-to-adhesive bonds provide a certain amount of rigidity to the interface, including structural strength, while at the same time allowing for the bond to be elastic enough to provide mechanical relief to the substrate segments 110 during expansion from thermal stress. The adhesive material 200 must provide physical properties that provide this mechanical relief and maintain compatibility with the intended application of the porous substrate 100.

The elastic modulus of the adhesive material 200 should be less than the elastic modulus of the substrate segment 110 so that it yields to the expansion of the segment, such as thermal expansion. If the elastic modulus of the adhesive is not less than the elastic modulus of the substrate, then mechanical stresses can accumulate in the substrate that may exceed the ultimate strength of the material, which may cause cracking to propagate within the substrate segments 110. The elastic modulus of the adhesive material must not be so low that the strength of the material is insufficient to maintain structural integrity. For example, the elastic modulus is desired to be less than, but greater than at least 20 to 30% of the elastic modulus of the substrate segment 110.

The Coefficient of Thermal Expansion (CTE) of the adhesive material 200 should be closely matched to the CTE of the substrate segments 110, e.g., at least within about 1×10⁻⁶° C⁻¹. A segmented substrate 100 applied in an environment at elevated temperatures, or where operating temperature is variable, may exhibit delamination of the adhesive material 200 from the substrate segments 100. The mechanical integrity of the segmented substrate 100 can be maintained in thermally variable environments with a CTE of the adhesive that is compatible with the CTE of the substrate, particularly if the elastic modulus of the adhesive is not significantly less than the substrate.

Other properties that must be considered when selecting an adhesive material 200 for a given substrate segment 110, in view of its intended operating environment, include thermal conductivity, Modulus of Rupture (MOR), maximum operating temperature, and chemical composition, among others. Thermal conductivity of the adhesive 200 affects the transfer rate of heat between adjoining segments 110 and/or the ability to extract heat from a segment, for example, to distribute thermal gradients along the length of the segments. MOR of the adhesive 200 is indicative of the strength of the material, and it is preferred that the MOR of the adhesive 200 is less than the MOR of the substrate segments. The maximum operating temperature of the adhesive 200 indicates the ability of the material to maintain structural integrity at operating temperatures. Similarly, the chemical composition of the adhesive indicates the ability of the material to be compatible with the environment of the intended application.

In the illustrative embodiment, an adhesive material 200 that is suitable for joining substrate segments for a diesel exhaust filter that is composed of alumina-silica fibers comprises a mixture of mullite fiber, with an inorganic binder or cement and an organic binder, diluted with water. The inorganic binder or cement is prepared by mixing alumina-silica fibers (67% to 72% by weight) with silica (25% to 30%) with oxides of magnesium (1% to 2%), titanium (0.5% to 2%), sodium (0.7% to 1%) and iron (0.5% to 1.5%). The binder or cement is diluted to approximately 60% to 70% solids in water.

In one example, an inorganic adhesive cement containing fibers, such as FIBERFRAX® QF-180 available from Unifrax Corporation, Niagara Falls N.Y., with modifications to match CTE and improve operating temperature capabilities, can be used as an inorganic binder to provide adhesive properties for assembly while maintaining strength and adhesion at elevated operating temperatures. This particular commercially available adhesive material is useful as a base material since it contains ceramic fiber as a constituent that operates to provide characteristics of low elastic modulus, and to promote the formation of fiber-to-fiber bonds at the segment—adhesive layer.

The inorganic binder or cement is then mixed with an organic binder, such as methyl cellulose compounds, like HPMC, which is used to provide plasticity suitable for application onto the substrate segments, as well as to provide low temperature bonding strength to support the joined substrates until the adhesive material 200 is fully cured. The materials are mixed with a fluid (typically a solvent, such as deionized water) to attain a desired consistency and rheology (viscosity) for application of the adhesive.

The combination of the materials used to formulate the adhesive 200 can be selected to minimize shrinkage when the adhesive is dried and cured. The moisture content is optimized when the consistency and rheology is sufficient for application on the substrate segments, but not excessively diluted. When excessive fluid quantities are added, the adhesive may be susceptible to cracking and separation/delamination when the assembled segments are dried. Materials can also be chosen that are comparatively less hydrophilic, that will require lesser quantities of the fluid to attain the desired consistency. For example, a low molecular weight HPMC can be selected as the organic binder, that requires less water to achieve the appropriate consistency for application, thereby resulting in fewer drying cracks within the adhesive layer 200.

Table 1 describes an exemplary mixture of the adhesive constituents according to the illustrative embodiment.

TABLE 1

| Material | Weight Percent |
|---|---|
| Alumina/Silica (Mullite phase) fiber | 22–45% |
| Inorganic binder or cement | 67–54% |
| Organic binder (HPMC) | <1% |
| Deionized water | <5% |

The adhesive 200 is disposed on the surface of one or both mating surfaces of the substrate segments 110 to be joined. The application of the adhesive can be performed in any number of methods known in the art. For example, the adhesive material 200 can be spread as a thin layer, similar to mortar, on one or both mating surfaces, with the adjoining segments being compressed together to form a uniform adhering layer. Alternatively, the adhesive material can be extruded into the space formed between two adjoining segments. Further still, a dispensing unit can dispense the adhesive in a pattern or matrix array on one or both mating surfaces of adjoining segments. When applying the adhesive material 200 using the various application methods, directional orientation of the fibers within the adhesive can be imparted to provide desired mechanical properties. A spacer, such as a ceramic shim can be placed at a plurality of positions within an adjoining interface to maintain a minimum separation or spacing between the adjoining segments, so that the resulting adhesive layer 200 does not become too thin to provide sufficient adhesive strength or elastic relief Optionally, when applying the adhesive 200, the surface of the substrate segments can be initially moistened with water to prevent moisture content from the adhesive being drawn into the substrate before the two segments are placed together, and to ensure uniform distribution of the adhesive 200 during application. The exposed ends of the substrate segments can be protected from inadvertent application of the adhesive material by covering the exposed ends of the segments with masking tape, or a clear mylar or adhesive tape. The assembled segmented substrate 100 is air dried and then heated to 120 degrees Celsius for approximately three to eight hours to dry the adhesive 200. The assembled segmented substrate 100 is then calcined at 1000 degrees Celsius for approximately 90 minutes to promote the formation of glass/ceramic bonds.

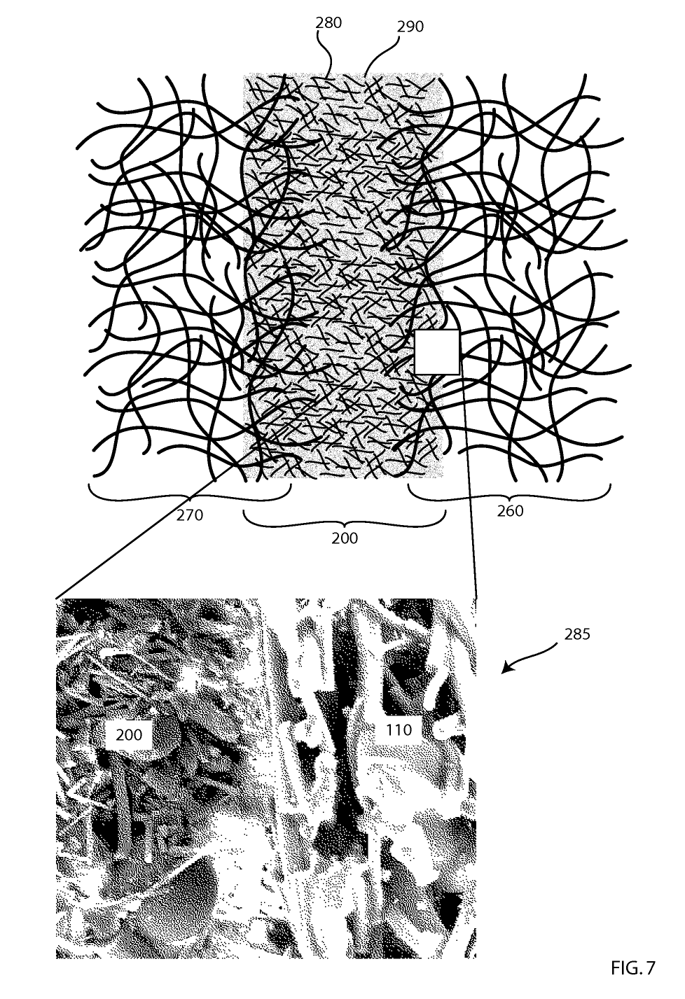

The adhesive material 200, when applied to the surface of the substrate segments 110 and cured, bonds to the fibrous structure of the porous material, forming bonds that encompass the fibers on the periphery of the substrate segment 110. When heating the assembly up to a calcination temperature, liquid phase sintering of the adhesive components results in the formation of bonds to the fibers of the segments. These bonds are initiated when the adhesive 200 is applied to the fibrous structure of the substrate segment 110, where fibers from the two adjoining surfaces are intermingled into each other, with the fibers occasionally lying on top of each other in an overlapping and crossing fashion. During the adhesive curing step, ceramic or glass, or glass-ceramic bonds develop across the fiber to fiber interconnects. As shown in FIG. 5, a detailed view of the joined region 250 is shown. When assembled, the substrate segments 110 are joined by the adhesive properties of the wet adhesive layer 200. As shown in FIG. 6, the detailed view of the joined region 250 is shown after the adhesive layer is cured. The adhesive 200 bonds to fibers in the periphery of the substrate segments 110, represented by dashed lines. FIG. 7 depicts the structure of the interface between a first segment 260 and a second segment 270, with the adhesive layer 200 joining the two segments. The adhesive layer 200 has a fibrous material component 280 and binder material component 290, with the adhesive layer 200 penetrating into, and bonding to, the outer periphery of the fibers of the first segment 260 and the second segment 270. As also shown in FIG. 7, a scanning electron microscopic image representation 285 of the interface portion between the adhesive layer 200 and the outer periphery of the fibers of the first segment 260 show fiber-to-fiber bonds between the fibers of the adhesive 200 and the fibers of the substrate segments 110. As shown in the scanning electron microscopic image representation 285 of the fibrous structure, the fibers within the segment 110 can be individual fibers bonded to adjacent fibers, and fibers bundled together, bonded to adjacent fibers, with the formation of fiber-to-fiber bonds at the adhesive layer 200 interface.

Thermal gradients may exist within a porous substrate during operation, particularly one used for filtration of exhaust gas in an internal combustion engine, for example, a diesel particulate filter. Mechanical stress is associated with thermal gradients proportional to the thermal coefficient of expansion of the substrate material. While extruded porous honeycomb substrates consisting essentially of fibers can be designed to minimize mechanical stress by selecting a material with a low coefficient of thermal expansion, the adhesive layer 200 in a segmented substrate 100 according to the present invention must consider the effects of thermally induced stress due to operational thermal gradients.

Fibers in the adhesive 200 provide for fiber-to-fiber bonds within the adhesive, and also effectively reduce the elastic modulus of the adhesive layer 200 in the segmented substrate 100 in order to manage thermally induced mechanical stress. Fibers in the adhesive 200 also reduce shrinkage when the adhesive 200 is dried and cured. In some cases, a design objective of the segmented substrate is to specify the elastic modulus of the adhesive 200 to be less than the elastic modulus of the substrate. In other words, the adhesive layer 200 must mechanically yield more than the substrate when mechanically stressed to prevent cracking of the substrate, and the inclusion of fibers in the structure of the adhesive layer provides for characteristics of the material that increase elasticity. In addition, the adhesive layer 200 also can provide a thermally insulating barrier between adjacent segments, thus limiting the thermal gradients to within a portion of the substrate 100, and not across the entire surface or volume. Additionally, the fibers in the adhesive layer 200 according to the present invention, bonded to the fibers of the substrate segment consisting essentially of fibrous material, provides sufficient strength of adhesion. It is desirable for the joint between the substrate segments 110 to be strong enough to withstand harsh operational conditions, including thermal and mechanical stresses observed during conditions of thermal shock, but it must also not be so strong that the segmented parts bear the stress and fail within the cells. Accordingly, it is desirable that when analyzed for mechanical strength, the segmented substrate 100 will fail within the adhesive layer 200, not within the substrate segments, or at the substrate-adhesive interface. A basic push test is typically used to measure the stress required to push one segment out of a joined substrate assembly.

In alternate embodiments the fibers of the adhesive can be obtained by grinding portions of cured substrate segments consisting of bonded ceramic fibers into a ground fibrous material or grinding ceramic fibrous materials similar in composition to the substrate segments. In these embodiments, the bonding fibers are substantially the same composition as the fibers of the porous substrate segment. The addition of fibers using ground substrate segments, or fibers having a composition similar to the substrate segment material, ensures that the CTE of the adhesive will be closely match to the substrate segments, while effectively reducing the modulus of elasticity. Further, the addition of fibers, either in a fibrous state, or from ground or crushed substrate materials, provides a reduction in elastic modulus due to the modulus reducing effect of relatively long fibers. Further still, powder-based ceramic material, such as silicon carbide particles or mullite (alumina-silica) powder can be added to the adhesive 200 to match the CTE of the adhesive to the substrate segments.

In an alternative illustrative embodiment, the adhesive 200 can be derived from the extrudable material by dilution of the mixture with additional fluid, or water, into a paste-like consistency, adjusting the viscosity so the adhesive can be evenly distributed between two adjacent segments that will be bonded together. The fibers within the extrudable mixture, with additives such as binder and pore former, are disposed on the surface of one or both mating sides of the substrate segments 110 to be joined. The adjacent substrate segments are assembled and heated to cure the adhesive 200, forming fiber-to-fiber bonds with the fibers of the substrate segments 110 and the fibers of the adhesive 200. In this embodiment, the segmented substrate 100 will have an appearance of a monolithic substrate, wherein the adhesive layer 200 will be nearly visibly indistinguishable from the substrate segments 110. In this illustrative embodiment, the bonding fibers are substantially the same composition as the fibers of the porous substrate. In some cases, it will be appreciated that the permeability through the adhesive layer 200 may be reduced in comparison to a channel wall of the substrate, due to the additional thickness of the adhesive layer, and due to the lower porosity of the adhesive layer.

In an alternative embodiment, substrate segments 110 composed essentially of silicon carbide fibers are joined into a segmented substrate 100. The adhesive material 200 suitable for joining substrate segments of this composition in one embodiment comprises a mixture of silicon carbide fibers, and/or silicon carbide powder with organic and inorganic binders, a cement, and a fluid, such as water. Alternatively, alumina-silica fibers, and/or mullite powder may be used within the adhesive material 200 to provide strength while effectively reducing the elastic modulus of the adhesive layer 200. Further, to prevent thermally induced stress during operation in an environment where thermal gradients may be present, the fiber additive to the adhesive layer should not increase the coefficient of thermal expansion of the adhesive layer 200 over the coefficient of thermal expansion of the material of the substrate segment 110.

In yet another alternative embodiment, substrate segments 110 composed essentially of cordierite fibers are joined into a segmented substrate 100. Cordierite, 2MgO.2Al₂O₃.5SiO₂, is the most commonly used ceramic material for monolithic catalyst support applications, such as vehicular catalytic converters. Cordierite is typically formed by calcining a mixture of kaolin, talc, alumina, aluminum hydroxide, and silica. The material exhibits a low coefficient of thermal expansion, though a relatively low melting point compared to mullite. The adhesive material 200 suitable for joining substrate segments of this composition must be compatible with the low coefficient of thermal expansion, and thus best comprises a mixture of cordierite fibers, with organic and inorganic binders, such as a cement material, and a fluid, such as water.

Referring back to FIG. 3, processing continues to filter fabrication assembly at step 160. With the fibrous substrate segments 110 joined and the adhesive 200 cured, the segmented substrate 100 is cut to size and shape, and further processed as necessary for its intended application. For example, a segmented substrate composed of four three-inch square cross section substrate segments can be cut into a desired shape, such as a 5.66 inch diameter cylinder, the standard size for diesel particulate filter in certain vehicles and applications. Further processing steps can include plugging alternate channels in the honeycomb to implement a wall-flow configuration. One skilled in the art will appreciate that that the wall-flow configuration of the honeycomb form can be implemented on the individual substrate segments prior to the joining step 150. In some cases, for example, where substrate segments 110 are cured in an inert environment and/or at high temperatures, such as SiC, the plugs necessary to form a wall-flow configuration, may be put in and cured or fired before the adhesive layer 200 is applied. After application of the adhesive layer, a second firing, typically at a lower temperature than the substrate firing, is used to cure the adhesive. Additional processing includes the application of a outer sealing layer, or skin, to provide a smooth outer coating necessary for visual appearance and for effective sealing when mounted in a housing or can. In some embodiments, the outer sealing layer, or skin, can be the same composition as the adhesive layer 200.

Alternatively, various aspects of the filter fabrication step 160 can be performed during the joining step 150. For example, to reduce the number of heating processes, the joined segmented substrate 100 can be cut to size and shape, with an application of the outer sealing layer. Both the adhesive layer 200 and the outer sealing layer can be cured simultaneously in a single curing operation. Further still, the plugging of alternate channels can also be performed prior to the calcination phase of curing the adhesive layer 200, to further minimize heating steps during processing. The organic binder and the cement content in the adhesive material 200, once dried, can provide sufficient green strength for subsequent processing until the calcination curing step can be performed. The curing step for all of the outer skin, plugging material and the adhesive layer 200 can be optionally combined into a single curing step. In this manner, the segmented substrate 100, joined with adhesive 200 is first dried and cut into its final shape, with the outer skin and plugging material applied. The curing step can be performed with a six-hour ramp in temperature to 1000 degrees Celsius, which is held for 90 minutes, and a six-hour ramp down to room temperature. The gradual heating rate ensures that a minimum thermal gradient builds up within the segmented substrate, to ensure a thorough and uniform cure of the adhesive 200, the plugs, and the outer skin.

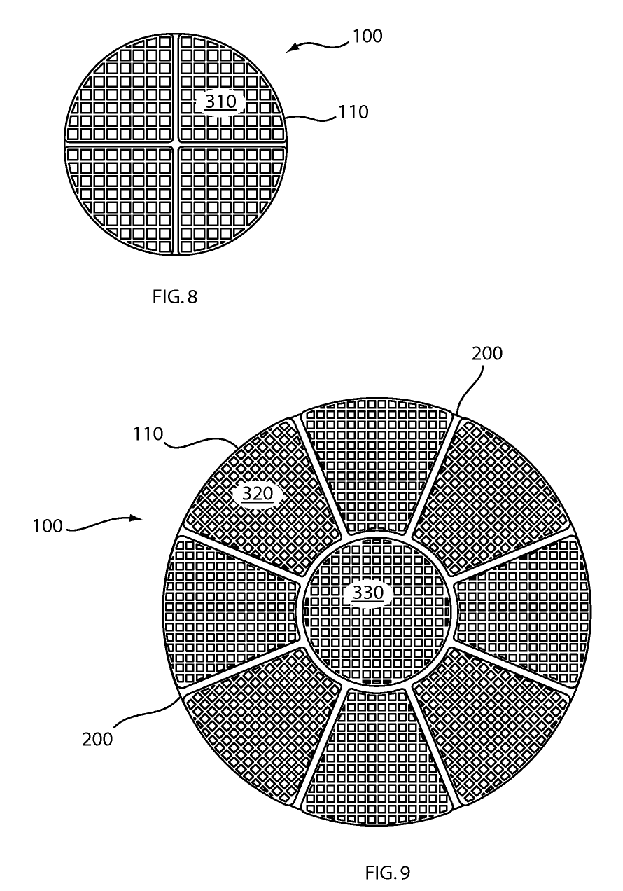

The segmented substrate 100 can be provided with substrate segments 110 in any number of geometric shapes. For example, as shown in FIG. 8, sub-circular, or pie-shaped segments 310 are extruded into a portion of a circle, such that when assembled using an adhesive layer 200, the resulting substrate is a cylindrical segmented substrate. Alternatively, as shown in FIG. 9, any number of geometric shapes can be assembled into a segmented substrate, for example, a plurality of wedge-shaped segments 320 are assembled around a cylindrical segment 330 using an adhesive layer 200, to provide a cylindrical substrate. The examples shown in FIG. 8 and FIG. 9 in such a way as to minimize or eliminate the need for an outer skin layer, since the sub-circular shaped segment 310 and the wedge-shaped segment 320 provide an outer layer by virtue of the extrusion process. Alternatively, any number of substrate segments 110 can be joined with an adhesive layer 200 to provide large segmented substrates 100 of nearly any size. For example, a nine-inch diameter substrate can be fabricated by adhering an array of nine or more three-inch square substrate segments.

Additional processing at fabrication step 160 may also include the application of a catalyst or washcoat so that the porous substrate can provide for catalyzed oxidation and/or reduction of materials that are directed through the substrate. For example, the segmented porous fibrous substrate 100, with a catalyst coating of a precious metal such as platinum, palladium (such as palladium oxide), rhodium, derivatives thereof including oxides, and mixtures thereof can be added to chemically alter the composition of exhaust gas from an internal combustion engine to reduce pollution in the engine emissions. The catalyst coating can be coated in layers or zones, or dispersed within the porous walls, or coated on the inner surface of the channels. Further, various compositions of catalyst can be selectively applied, such as on the walls of the channels or dispersed within the porous walls to facilitate the catalytic oxidation of soot particles that collect within the channels, and to catalytically reduce exhaust gases that pass through the porous walls. Additional processing for filter fabrication 160 can also include mounting the segmented substrate in a housing or can. Typically, these operations may induce mechanical stress on the substrate since compression of the housing around the substrate is necessary to ensure a gas-tight seal.

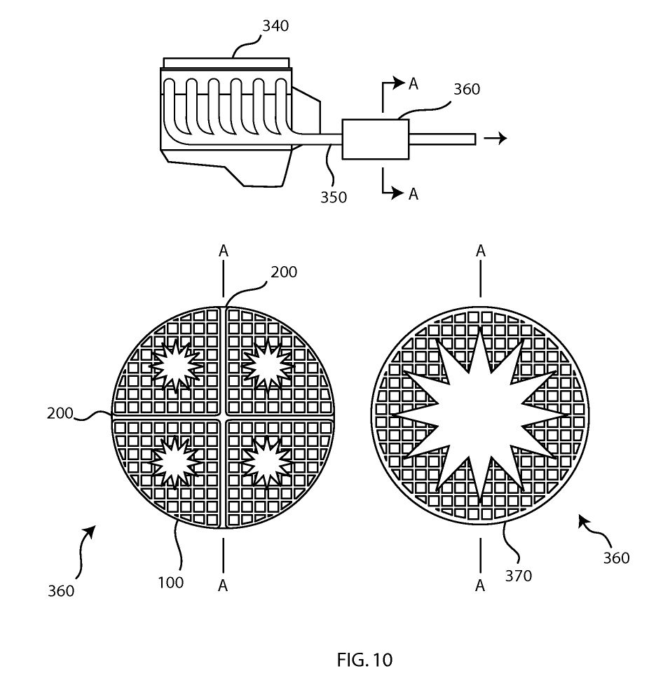

An exemplary application of the present invention includes the use of the segmented substrate 100 in an exhaust filtration application for an internal combustion engine. More specifically, the segmented substrate, configured as a wall-flow porous filter, can be used, for example, as a diesel particulate filter, selective catalyst reduction (SCR) units, NOx reducing units, Lean NOx Traps (LNT), and three- and four-way catalytic converters. Referring to FIG. 10, the advantages of the present invention can be readily seen. A diesel particulate filter 360 captures and extracts soot (un-burned hydrocarbon particles) from the exhaust stream of a diesel engine 340. The exhaust pipes 350 from the diesel engine 340 are routed through the diesel particulate filter 360 having the segmented filter 100 configured as a wall-flow filter mounted within. In other words, the entire exhaust stream is directed through the porous walls of the filter, where soot particles accumulate. Diesel particulate filters must periodically regenerate to burn off the accumulated soot particles to prevent a build-up that increases backpressure in the exhaust system that effectively reduce the efficiency of the diesel engine. Regeneration, whether controlled by the engine management system, or uncontrolled, is the combustion of the accumulated soot in the filter. The porous filter substrate that accumulates soot can be coated with a catalyst or a washcoat to catalyze the oxidation of the un-burned hydrocarbons so that the regeneration can continuously occur, or at least be capable of initiation at lower relative temperatures. Referring still to FIG. 10, a cross sectional view of the diesel particulate filter 360, indicated by the A-A reference line, is shown regenerating, comparatively as the segmented filter 100 and a monolithic filter 370. When a segmented filter 100 of filter segments adhered with an adhesive layer 200 is used, the regeneration combustion initiates in, and is contained in, any one, or a plurality of substrate segments 110. By comparison, the monolithic filter 370 initiates a regeneration combustion that burns throughout the entire filter. By constraining the regeneration to a portion of the filter cross-sectional area, the thermal stress that may result from the combustion of regeneration within a segment is relieved by the elasticity of the adhesive layer 200 between adjoining segments. Additionally, since the adhesive layer 200 is not as porous as the channel walls of the porous fibrous honeycomb, the flow of the exhaust stream does not flow through the adhesive layer, causing the flow to be more broadly distributed over the face of the filter, resulting in soot loadings that are more distributed over the cross-sectional area of the filter. In a monolithic filter, by contrast, the distribution of soot tends to be concentrated in the center of the filter. Soot loadings that are more evenly distributed have been shown to regenerate with smaller thermal gradients, resulting in reduced thermally induced stress.

The present invention can also be applied in segmented substrates used for gasoline exhaust filtration, including gasoline direct injection, and two stroke engines in catalytic converters and NOx adsorbers. Additionally, without limitation, other applications include abatement of volatile organic compounds, chemical refineries, fuel reformers, fuel cell reformate cleanup, as well as regenerator cores, catalysts for desulfurization, hydrocracking, and hydrotreating.

While the invention has been illustrated and described in detail and with reference to specific embodiments thereof, it will be apparent to those skilled in the art that various changes and modifications can be made therein without departing from the spirit and scope of thereof. Thus, it is intended that the present invention cover the modifications and variations of this invention provided they come within the scope of the appended claims and their equivalents.

What is claimed is:

1. A porous substrate comprising:
a plurality of extruded honeycomb porous fibrous substrate segments, each of the plurality of segments produced by;
a) mixing fibers, organic and inorganic additives, and fluid to form an extrudable mixture;
b) extruding the extrudable mixture into a green honeycomb substrate; and
c) curing the green honeycomb substrate to provide an extruded porous honeycomb substrate segment comprising bonded fibers; and
an adhesive layer bonded to the fibers of the extruded honeycomb substrate segments joining the plurality of extruded honeycomb substrate segments into the porous substrate.

2. The porous substrate according to claim 1 wherein the fibers are ceramic.

3. The porous substrate according to claim 1 wherein the adhesive layer comprises fibers of substantially the same composition as the bonded fibers.

4. The porous substrate according to claim 1 wherein the porous structure has a porosity greater than 60%.

5. The porous substrate according to claim 1 wherein the adhesive layer comprises an inorganic fiber, an inorganic binder, and an organic binder.

6. The porous substrate according to claim 5 wherein the adhesive layer bonded to the fibers comprise at least one of cement bonds, glass bonds, ceramic bonds, amorphous bonds, and crystalline bonds.

7. The porous substrate according to claim 1 wherein the adhesive layer bonded to the fibers comprise a liquid state sintered bonds.

8. A method of fabricating a fibrous honeycomb substrate, the method comprising:
mixing fibers with additives and a fluid to form an extrudable mixture;
extruding the extrudable mixture into a plurality of green honeycomb substrate sections;
curing the green substrate sections to provide a plurality of fibrous honeycomb substrate sections; and
joining the plurality of fibrous honeycomb substrate sections using an adhesive layer to form bonds to the fibers of the substrate sections.

9. The method according to claim 8 wherein the adhesive further comprises an organic binder.

10. The method according to claim 8 wherein the adhesive layer comprises fibers having substantially the same composition as the fibers in the mixing step.

11. The method according to claim 8 wherein the adhesive comprises the extrudable mixture.

12. The method according to claim 8 wherein the step of joining the plurality of fibrous honeycomb substrate sections comprises applying a paste comprising the extrudable mixture to the substrate sections, and applying a clamping pressure.

13. The method according to claim 8 wherein the step of joining the plurality of fibrous honeycomb substrate sections comprises applying a paste comprising the fibers to the substrate sections, and applying a clamping pressure.

14. A porous substrate comprising:
a plurality of extruded honeycomb substrate sections consisting essentially of bonded fibers;
the plurality of extruded honeycomb substrate sections joined by an adhesive layer having glass/ceramic bonds within the bonded fibers.

15. The porous substrate according to claim 14 wherein the fibers comprise a ceramic fiber.

16. The porous substrate according to claim 14 wherein the extruded honeycomb substrate sections are extruded into a sub-circular section.

17. The porous substrate according to claim 14 wherein the porous substrate further comprises an outer skin coating.

18. The porous substrate according to claim 14 wherein the extruded honeycomb substrate sections are alternatively plugged to form a wall-flow filter.

19. An exhaust filtration system comprising:
an internal combustion engine having an exhaust; and
a ceramic substrate coupled to the exhaust, the ceramic substrate comprising a plurality of extruded honeycomb porous fibrous substrate segments, each of the plurality of substrates joined to at least one other of the plurality of substrate segments with an adhesive layer that bonds to fibers of the respective substrate segment.

20. The exhaust filtration system according to claim 19 wherein each of the extruded honeycomb porous fibrous substrate segments of the diesel particulate filter further comprises a wall-flow configuration.
